(19) United States
(12) Patent Application Publication
(10) Pub. No.: US 2024/0017754 A1
(43) Pub. Date: Jan. 18, 2024

(54) Pet Assistance Step Device

(71) Applicant: Rhonda Gilliam, Mesquite, TX (US)

(72) Inventor: Rhonda Gilliam, Mesquite, TX (US)

(21) Appl. No.: 17/864,127

(22) Filed: Jul. 13, 2022

(51) Int. Cl. B62B 1/12; A01K 1/035

(52) U.S. Cl. CPC B62B 1/12; A01K 1/035

(57) ABSTRACT

A pet assistance step device for assisting a pet in ascending to a destination surface includes a hand truck having a base frame, a handle frame extending perpendicularly from the base frame, and a pair of wheels rotationally coupled to one of the handle frame or the base frame. The hand truck is constructed of a rigid material and is configured for positioning a bottom surface of the base frame on a support surface. A platform is coupled to the base frame which has a top surface facing away from the base frame configured for supporting a pet at a height lower than the height of a destination surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to step devices and more particularly pertains to a new step device for assisting a pet in ascending to a destination surface.

### (2) Description of Related Art Including Information Disclosed Under 37 CFR 1.97 and 1.98

The prior art relates to step devices which assist pets in reaching elevated destination surfaces. These devices disclose stepped apparatuses or ramps which either removably attach to the destination surface, position next to the destination surface, or unfold from the destination surface. However, none of the devices in the prior art relate to a device which utilizes a hand truck with a collapsible handle and elevated platform for positioning next to the destination surface.

### BRIEF SUMMARY OF THE INVENTION

An embodiment of the disclosure meets the needs presented above by generally comprising a hand truck having a base frame, a handle frame extending perpendicularly from the base frame, and a pair of wheels rotationally coupled to one of the handle frame or the base frame. The hand truck is constructed of a rigid material and is configured for positioning a bottom surface of the base frame on a support surface. A platform is coupled to the base frame which has a top surface facing away from the base frame configured for supporting a pet at a height lower than the height of a destination surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a pet assistance step device according to an embodiment of the disclosure.

FIG. 2 is a rear view of an embodiment of the disclosure.

FIG. 3 is a left side view of an embodiment of the disclosure.

FIG. 4 is a right side detail view of an embodiment of the disclosure.

FIG. 5 is a top view of an embodiment of the disclosure.

FIG. 6 is a bottom view of an embodiment of the disclosure.

FIG. 7 is an in-use view of an embodiment of the disclosure.

### DETAILED DESCRIPTION OF THE INVENTION

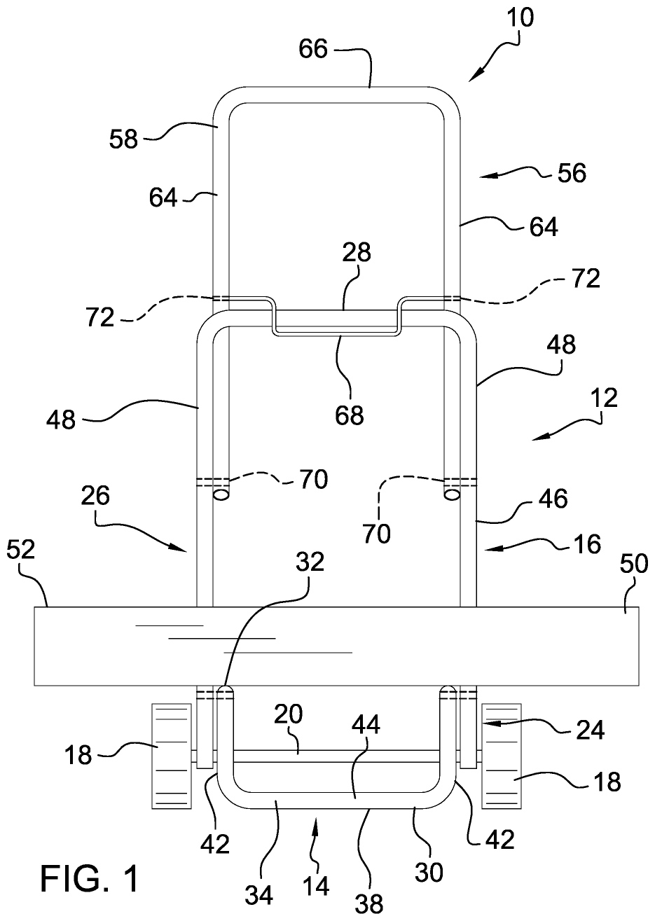

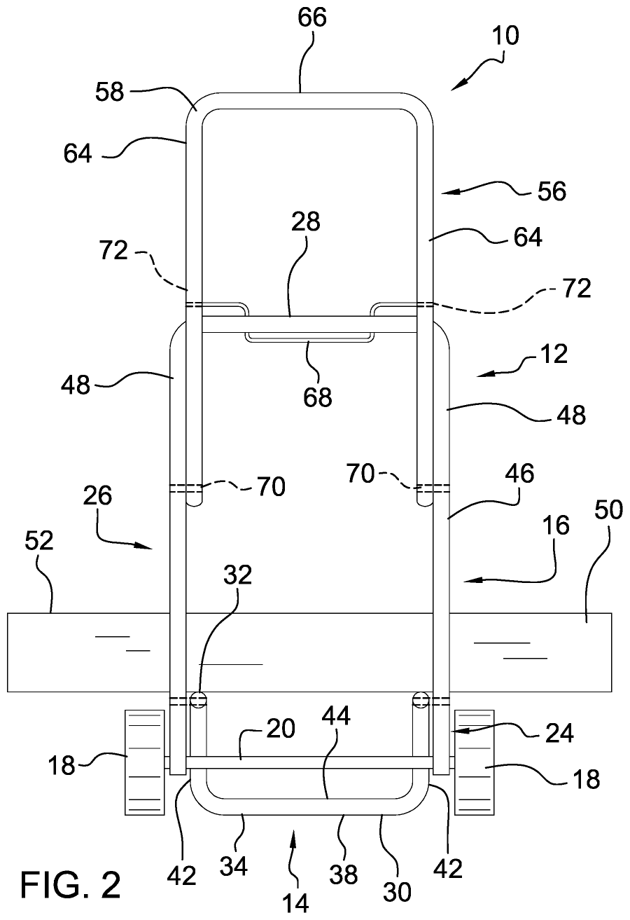

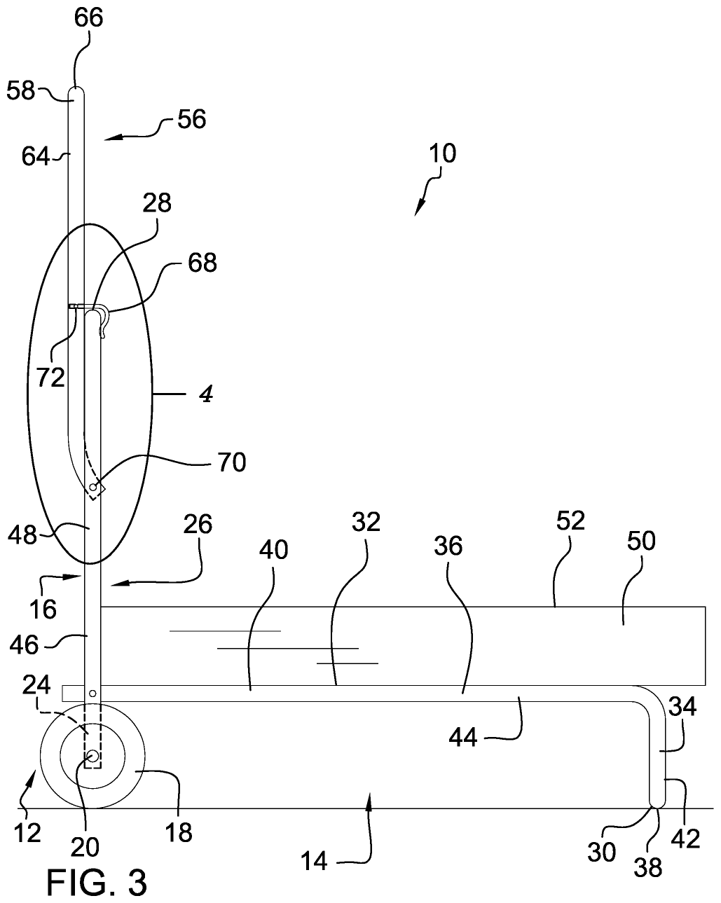

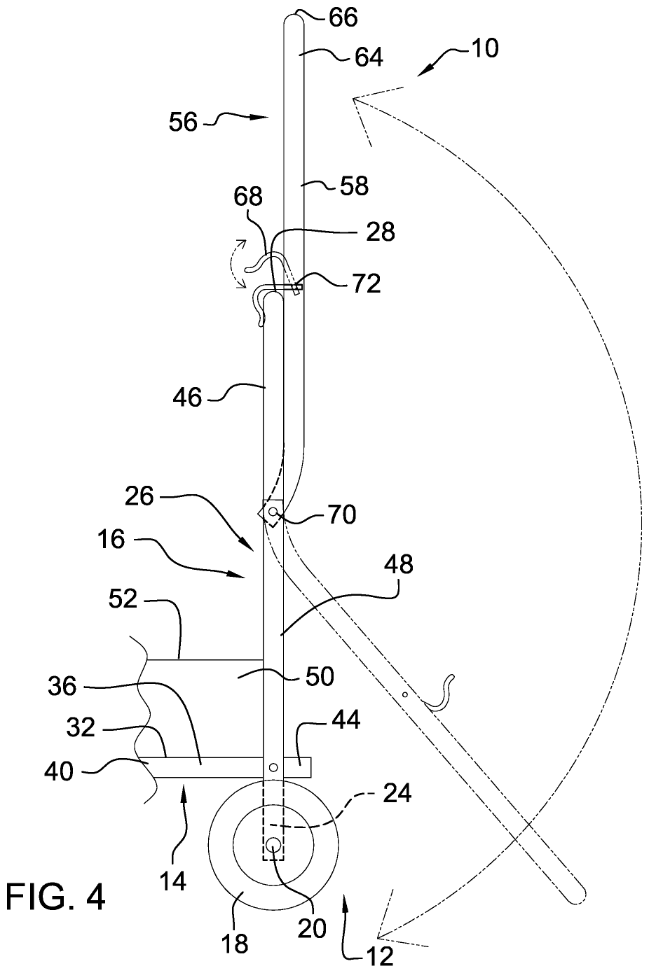

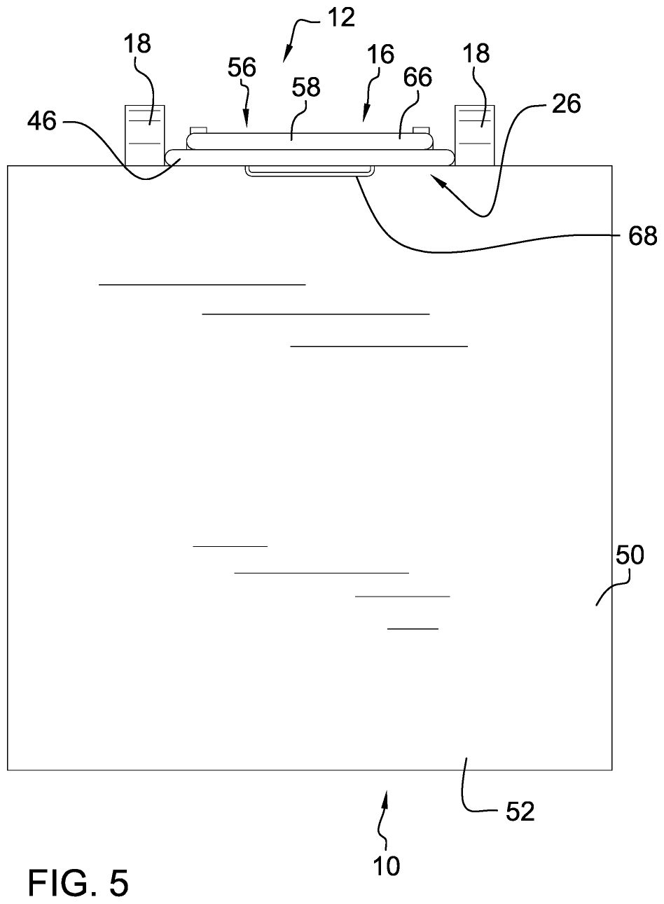

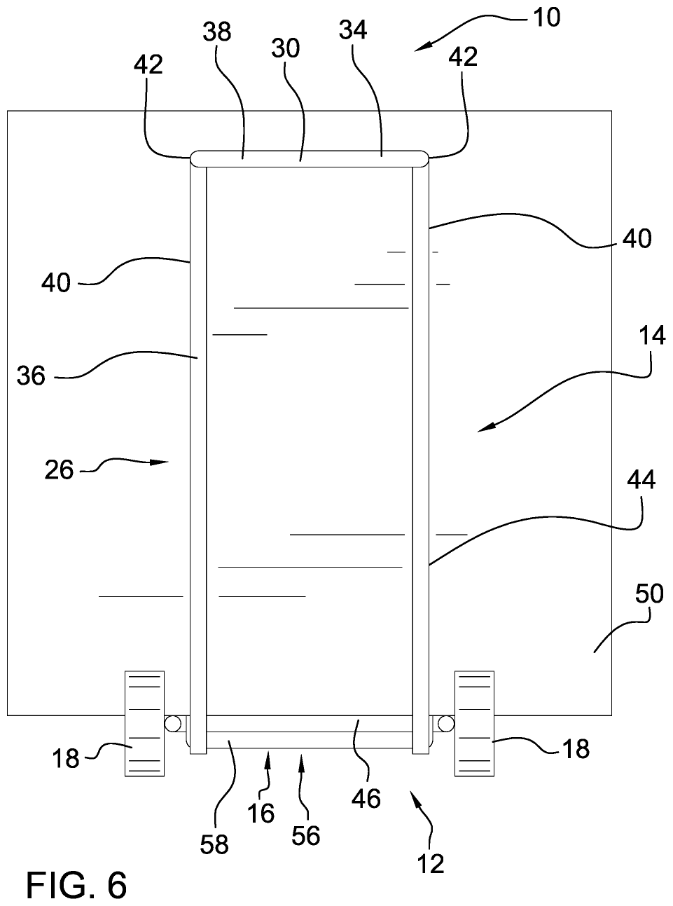

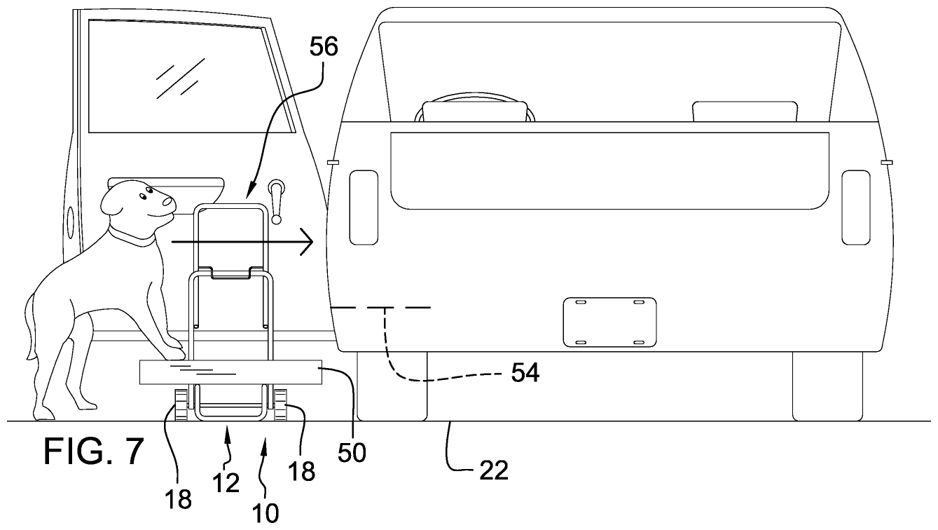

With reference now to the drawings, and in particular to FIGS. 1 through 7 thereof, a new step device embodying the principles and concepts of an embodiment of the disclosure and generally designated by the reference numeral 10 will be described.

As best illustrated in FIGS. 1 through 7, the pet assistance step device 10 generally comprises a hand truck 12 constructed of a rigid material. The hand truck 12 has a base frame 14, a handle frame 16 extending perpendicularly from the base frame 14, a pair of wheels 18, and an axle rod 20. The axle rod 20 couples the pair of wheels 18 to each other and rotationally couples the pair of wheels 18 to the handle frame 16. The pair of wheels 18 is configured for moving the hand truck 12 across a support surface 22. The handle frame 16 has a lower portion 24 extending from the pair of wheels 18 to the base frame 14 and an upper portion 26 extending between the base frame 14 and a top end 28 of the handle frame 16. The base frame 14 has a bottom surface 30 and a top surface 32 opposite the bottom surface 30. The base frame 14 is configured for positioning of the bottom surface 30 of the base frame 14 on the support surface 22.

The base frame 14 includes a first portion 34 and a second portion 36, the second portion 36 of the base frame 14 extending between the first portion 34 of the base frame 14 and the handle frame 16. The first portion 34 of the base frame 14 is perpendicular to the second portion 36 of the base frame 14 and has a distal end 38 relative to the second portion 36, which is configured for positioning on the support surface 22. The second portion 36 of the base frame 14 has a pair of lateral sides 40 extending from the first portion 34 of the base frame 14 to the handle frame 16, and the first portion 34 of the base frame 14 has a pair of lateral sides 42 extending from the second portion 36 of the base frame 14 to the distal end 38 of the first portion 34 of the base frame 14. Each of the pair of lateral sides 42 of the first portion 34 of the base frame 14 is coplanar with an associated lateral side 40 of the second portion 36 of the base frame 14 and is perpendicular to the handle frame 16.

The base frame 14 is formed of a base frame tube 44. The base frame tube 44 extends continuously from the handle frame 16 along one of the lateral sides 40 of the second portion 36 of the base frame 14 to the first portion 34 of the base frame 14, along one of the lateral sides 42 of the first portion 34 of the base frame 14 from the second portion 36 of the base frame 14 to the distal end 38 of the first portion 34 of the base frame 14, along the distal end 38 of the first portion 34 of the base frame 14 from the one of the lateral sides 42 of the first portion 34 of the base frame 14 to another lateral side 42 of the first portion 34 of the base frame 14, along the other lateral side 42 of the first portion 34 of the base frame 14 from the distal end 38 of the first portion 34 of the base frame 14 to the second portion 36 of the base frame 14, and along another lateral side 40 of the second portion 36 of the base frame 14 from the first portion 34 of the base frame 14 to the handle frame 16.

The handle frame 16 is formed of a handle frame tube 46. The handle frame tube 46 extends continuously from one of the wheels 18 to the base frame 14, from the base frame 14 to the top end 28 of the handle frame 16, along the top end 28 of the handle frame 16, from the top end 28 of the handle frame 16 to the base frame 14, and from the base frame 14 to another wheel 18. The handle frame 16 has a pair of upright portions 48 which extends between an associated wheel 18 and the top end 28 of the handle frame 16.

A platform 50 is coupled to the top surface 32 of the base frame 14 and is constructed of a rigid material. The platform 50 has a top surface 52 facing away from the base frame 14 which is configured for supporting a pet when the base frame 14 is positioned on the support surface 22. The platform 50 and the base frame 14 are cooperatively configured to have a step height between the top surface 32 of the platform 50 and the support surface 22 less than a destination surface height between the destination surface 54 and the support surface 22. A cover constructed of a resiliently compressible material may encase the platform 50, thereby providing a cushioned surface on the platform 50.

A handle 56 is pivotably coupled to the handle frame 16 and is movable between a collapsed position and a deployed position. The handle frame 16 extends away from the base frame 14 past the handle 56 when the handle 56 is in the collapsed position, and the handle 56 extends away from the base frame 14 past the handle frame 16 when the handle 56 is in the deployed position. The handle 56 has a pair of extension portions 64, each of which extend from an associated upright portion 48 of said handle frame 16 to a distal end 66 of the handle 56 relative to the handle frame 16. The handle 56 is formed of a handle tube 58 which extends from one upright portion 48 of the handle frame 16 to the distal end 66 of the handle 56, along the distal end 66 of the handle 56, and from the distal end 66 of the handle 56 to another upright portion 48 of the handle frame 16.

The platform 50 may be constructed of a hollow plastic or like material. The base frame 14, handle frame 16, and handle 56 may be constructed of metal, plastic, or like material.

A retainer clip 68 is pivotably coupled to the handle 56. The retainer clip 68 is elastically clampable and removably couplable to the handle frame 16 when the handle 56 is in the deployed position, the retainer clip 68 clamping the top end 28 of the handle frame 16 when coupling to the handle frame 16. Each of a pair of handle pins 70 rotationally couples the handle 56 to an associated upright portion 48 of the handle frame 16, and each of a pair of retainer clip pins 72 rotationally couples the retainer clip 68 to an associated extension portion 64 of the handle 56.

In use, the device is positioned on the support surface 22 next to the destination surface 54, providing the platform 50 as an intermediate surface for a pet to step onto as it travels to or from the destination from or to the support surface 22 respectively. When not in use for providing an intermediate surface, the retainer clip 68 may be decoupled from the handle frame 16 and the handle 56 pivotably moved to the collapsed position, thus facilitating storage in a space too small for the device when the handle 56 is in the deployed position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet assistance step device comprising:
a hand truck, said hand truck having a base frame, a handle frame extending perpendicularly from said base frame, and a pair of wheels rotationally coupled to one of said handle frame or said base frame, said pair of wheels being configured for moving said hand truck across a support surface, said base frame having a bottom surface and a top surface opposite said bottom surface, said hand truck being constructed of a rigid material, said base frame being configured for positioning of said bottom surface of said base frame on the support surface; and
a platform, said platform being coupled to said top surface of said base frame, said platform being constructed of a rigid material, said platform having a top surface facing away from said base frame, said platform being configured for supporting a pet on said top surface of said platform when said base frame is positioned on the support surface, said platform and said base frame being cooperatively configured to have a step height between said top surface of said platform and said support surface less than a destination surface height between said destination surface and said support surface.

2. The device of claim 1, further comprising a handle, said handle being movably coupled to said handle frame, said handle being movable between a collapsed position and a deployed position, said handle frame extending away from said base frame past said handle when said handle is in said collapsed position, said handle extending away from said base frame past said handle frame when said handle is in said deployed position.

3. The device of claim 1, wherein said base frame includes a first portion and a second portion, said second portion of said base frame extending between said first portion of said base frame and said handle frame, said first portion of said base frame having a distal end relative to said second portion, said distal end of said first portion of said base frame being configured for positioning on the support surface, said second portion of said base frame having a pair of lateral sides extending from said first portion of said base frame to said handle frame, said first portion of said base frame having a pair of lateral sides extending from said second portion of said base frame to said distal end of said first portion of said base frame.

4. The device of claim 3, wherein said base frame is formed of a base frame tube, said base frame tube extending from said handle frame along one of said lateral sides of said second portion of said base frame to said first portion of said base frame, said base frame tube extending along one of said lateral sides of said first portion of said base frame from said second portion of said base frame to said distal end of said first portion of said base frame, said base frame tube extending along said distal end of said first portion of said base frame from said one of said lateral sides of said first portion of said base frame to another lateral side of said first portion of said base frame, said base frame tube extending along said other lateral side of said first portion of said base frame from said distal end of said first portion of said base frame to said second portion of said base frame, said base frame tube extending along another lateral side of said second portion of said base frame from said first portion of said base frame to said handle frame.

5. The device of claim 3, wherein said first portion of said base frame is perpendicular to said second portion of said base frame.

6. The device of claim 3, wherein each of said pair of lateral sides of said first portion of said base frame is coplanar with an associated lateral side of said second portion of said base frame.

7. The device of claim 6, wherein said pair of lateral sides of said second portion of said base frame is perpendicular to said handle frame.

8. The device of claim 1, wherein said pair of wheels is coupled to said handle frame, said handle frame having a lower portion extending from said pair of wheels to said base frame and an upper portion extending between said base frame and a top end of said handle frame.

9. The device of claim 8, wherein said lower portion of said handle frame and said upper portion of said handle frame are coplanar.

10. The device of claim 8, wherein said handle frame is formed of a handle frame tube, said handle frame tube extending from one of said wheels to said base frame, said handle frame tube extending from said base frame to said top end of said handle frame, said handle frame tube extending along said top end of said handle frame, said handle frame tube extending from said top end of said handle frame to said base frame, said handle frame tube extending from said base frame to another wheel.

11. The device of claim 9, wherein said handle frame has a pair of upright portions, each said upright portion extending between an associated wheel and said top end of said handle frame, each said upright portion being perpendicular to said second portion of said base frame.

12. The device of claim 1, wherein said hand truck further comprises an axle rod, said axle rod coupling said pair of wheels to each other and rotationally coupling said pair of wheels to at least one of said handle frame or said base frame.

13. The device of claim 2, wherein said handle is pivotably coupled to said handle frame, said handle having a pair of extension portions, each said extension portion extending from an associated upright portion of said handle frame to said distal end of said handle.

14. The device of claim 13, further comprising a retainer clip, said retainer clip being movably coupled to said handle, said retainer clip being removably couplable to said handle frame when said handle is in said deployed position, said retainer clip securing said handle in said deployed position when said retainer clip couples to said handle frame.

15. The device of claim 14, wherein said retainer clip is pivotably coupled to said handle, said retainer clip being elastically clampable, said retainer clip clamping said top end of said handle frame when coupling to said handle frame.

16. The device of claim 13, wherein said handle is formed of a handle tube, said handle tube extending from one said upright portion of said handle frame to said distal end of said handle, said handle tube extending along said distal end of said handle, said handle tube extending from said distal end of said handle to another upright portion of said handle frame.

17. The device of claim 16, further comprising:
a pair of handle pins, each said handle pin rotationally coupling said handle to an associated upright portion of said handle frame; and
a pair of retainer clip pins, each said retainer clip pin rotationally coupling said retainer clip to an associated extension portion of said handle.

18. The device of claim 1, further comprising a cover, said cover encasing said platform, said cover being constructed of a resiliently compressible material.

19. The device of claim 1, wherein said platform is constructed of a hollow, molded plastic.

20. The device of claim 2, wherein said base frame, said handle frame, and said handle are constructed of plastic.

21. The device of claim 2, wherein said base frame, said handle frame, and said handle are constructed of metal.

22. A pet assistance step device comprising:
a hand truck, said hand truck having a base frame, a handle frame extending perpendicularly from said base frame, a pair of wheels, and an axle rod, said axle rod coupling said pair of wheels to each other and rotationally coupling said pair of wheels to said handle frame, said pair of wheels being configured for moving said hand truck across a support surface, said handle frame having a lower portion extending from said pair of wheels to said base frame and an upper portion extending between said base frame and a top end of said handle frame, said base frame having a bottom surface and a top surface opposite said bottom surface, said hand truck being constructed of a rigid material, said base frame being configured for positioning of said bottom surface of said base frame on the support surface,
said base frame including a first portion and a second portion, said second portion of said base frame extending between said first portion of said base frame and said handle frame, said first portion of said base frame having a distal end relative to said second portion, said distal end of said first portion of said base frame being configured for positioning on the support surface, said second portion of said base frame having a pair of lateral sides extending from said first portion of said base frame to said handle frame, said first portion of said base frame having a pair of lateral sides extending from said second portion of said base frame to said distal end of said first portion of said base frame,
said first portion of said base frame being perpendicular to said second portion of said base frame,
each of said pair of lateral sides of said first portion of said base frame being coplanar with an associated lateral side of said second portion of said base frame,
said pair of lateral sides of said second portion of said base frame being perpendicular to said handle frame,
said base frame being formed of a base frame tube, said base frame tube extending from said handle frame along one of said lateral sides of said second portion of said base frame to said first portion of said base frame, said base frame tube extending along one of said lateral sides of said first portion of said base frame from said second portion of said base frame to said distal end of said first portion of said base frame, said base frame tube extending along said distal end of said first portion of said base frame from said one of said lateral sides of said first portion of said base frame to another lateral side of said first portion of said base frame, said base frame tube extending along said other lateral side of said first portion of said base frame from said distal end of said first portion of said base frame to said second portion of said base frame, said base frame tube extending along another lateral side of said second portion of said base frame from said first portion of said base frame to said handle frame,
said handle frame being formed of a handle frame tube, said handle frame tube extending from one of said wheels to said base frame, said handle frame tube extending from said base frame to said top end of said handle frame, said handle frame tube extending along said top end of said handle frame, said handle frame tube extending from said top end of said handle frame to said base frame, said handle frame tube extending from said base frame to another wheel,
said handle frame having a pair of upright portions, each said upright portion extending between an associated wheel and said top end of said handle frame;
a platform, said platform being coupled to said top surface of said base frame, said platform being constructed of a rigid material, said platform having a top surface facing away from said base frame, said platform being configured for supporting a pet on said top surface of said platform when said base frame is positioned on the support surface, said platform and said base frame being cooperatively configured to have a step height between said top surface of said platform and said support surface less than a destination surface height between said destination surface and said support surface;
a handle, said handle being pivotably coupled to said handle frame, said handle being movable between a collapsed position and a deployed position, said handle frame extending away from said base frame past said handle when said handle is in said collapsed position, said handle extending away from said base frame past said handle frame when said handle is in said deployed position, said handle having a pair of extension portions, each said extension portion extending from an associated upright portion of said handle frame to a distal end of said handle relative to said handle frame,
said handle being formed of a handle tube, said handle tube extending from one said upright portion of said handle frame to said distal end of said handle, said handle tube extending along said distal end of said handle, said handle tube extending from said distal end of said handle to another upright portion of said handle frame;
a retainer clip, said retainer clip being pivotably coupled to said handle, said retainer clip being elastically clampable, said retainer clip being removably couplable to said handle frame when said handle is in said deployed position, said retainer clip clamping said top end of said handle frame when coupling to said handle frame;
a pair of handle pins, each said handle pin rotationally coupling said handle to an associated upright portion of said handle frame; and
a pair of retainer clip pins, each said retainer clip pin rotationally coupling said retainer clip to an associated extension portion of said handle.
